(19) United States
(12) Patent Application Publication
(10) Pub. No.: US 2009/0031915 A1
(43) Pub. Date: Feb. 5, 2009

(54) Locomotive Truck and Method for Distributing Weight Asymmetrically to Axles of the Truck

(76) Inventors: Ajith Kuttannair Kumar, Erie, PA (US); Bret Dwayne Worden, Union City, PA (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 11/833,819

(22) Filed: Aug. 3, 2007

(51) Int. Cl. B61C 11/00; F16F 1/00

(52) U.S. Cl. 105/34.1; 267/3

(57) ABSTRACT

A locomotive truck and method for distributing weight asymmetrically to axles of the truck includes a first axle of a locomotive truck uncoupled from a traction system of the locomotive and a first suspension assembly coupling the first axle to the truck for applying to the first axle a first portion of a locomotive weight. The truck also includes a second axle coupled to the traction system and a second suspension assembly coupling the second axle to the truck for applying to the second axle a second portion of the locomotive weight greater than the first portion so that weight is asymmetrically distributed to the first axle and the second axle so as to transmit a corresponding incremental amount of tractive effort for a given amount of a driving torque applied to the second axle via the traction system of the locomotive.

### FIELD OF THE INVENTION

The subject matter herein relates to locomotives, and, more particularly, to a locomotive truck for distributing weight asymmetrically to the axles of the truck.

### BACKGROUND OF THE INVENTION

A diesel-electric locomotive typically includes a diesel internal combustion engine coupled to drive a rotor of at least one traction alternator to produce alternating current (AC) electrical power. The traction alternator may be electrically coupled to power one or more electric traction motors mechanically coupled to apply torque to one or more axles of the locomotive. The traction motors may include AC motors operable with AC power, or direct current motors operable with direct current (DC) power. For DC motor operation, a rectifier may be provided to convert the AC power produced by the traction alternator to DC power for powering the DC motors.

AC-motor-equipped locomotives typically exhibit better performance and have higher reliability and lower maintenance than DC motor equipped locomotives. In addition, more responsive individual motor control may be provided in AC-motor-equipped locomotives, for example, via use of inverter-based motor control. However, DC-motor-equipped locomotives are relatively less expensive than comparable AC-motor-equipped locomotives. Thus, for certain hauling applications, such as when hauling relatively light freight and/or relatively short trains, it may be more cost efficient to use a DC-motor-equipped locomotive instead of an AC-motor-equipped locomotive.

For relatively heavy hauling applications, diesel-electric locomotives are typically configured to have two trucks including three powered axles per truck. Each axle of the truck is typically coupled, via a gear set, to a respective motor mounted in the truck near the axle. Each axle is mounted to the truck via a suspension assembly that typically includes one or more springs for transferring a respective portion of a locomotive weight (including a locomotive body weight and a locomotive truck weight) to the axle while allowing some degree of movement of the axle relative to the truck.

A locomotive body weight is typically configured to be about equally distributed between the two trucks. The locomotive weight is usually further configured to be symmetrically distributed among the axles of the trucks. For example, a conventional locomotive weighing 420,000 pounds is typically configured to equally distribute weight to the six axles of the locomotive, so that each axle supports a force of 420,000/6 pounds per axle, or 70,000 pounds per axle.

Locomotives are typically manufactured to distribute weight symmetrically to the trucks and then to the axles of the trucks so that relatively equal portions of the weight of the locomotive are distributed to the axles. Typically, the weight of the locomotive and the power rating of the locomotive determine a tractive effort capability rating of the locomotive that may be expressed as weight times a tractive effort rating. Accordingly, the weight applied to each of the axles times the tractive effort that can be applied to the axle determines a power capability of the corresponding axle. Consequently, the heavier a locomotive, the more tractive effort that it can generate at a certain speed. Additional weight, or ballast, may be added to a locomotive to bring it up to a desired overall weight for achieving a desired tractive effort capability rating. For example, due to manufacturing tolerances that may result in varying overall weights among locomotives built to a same specification, locomotives are commonly configured to be slightly lighter than required to meet a desired tractive effort rating, and then ballast is added to reach a desired overall weight capable of meeting the desired tractive effort rating.

Diesel engine powered locomotives represent a major capital expenditure for railroads, including both the initial purchase of a locomotive, but also the ongoing expense of maintaining and repairing the locomotive. In addition, hauling requirements may change over time for the railroad, so that a locomotive having a certain operating capability at a time of purchase may not meet the hauling needs of the railroad in the future. For example, a railroad looking to purchase a locomotive may only have minimal hauling needs that may be met by a relatively inexpensive low tractive effort capability locomotive, such as a DC powered locomotive having less hauling capability compared to a more expensive relatively high tractive effort locomotive, such as an AC powered locomotive. However, at some point in the useful life of the low tractive effort capability locomotive, hauling needs of the railroad may change, such that the low tractive effort capability locomotive may not be able to provide sufficient hauling capability. As a result, the railroad may need to purchase a more capable high tractive effort capability locomotive, thereby sacrificing a remaining useful life of the low tractive effort capability locomotive.

The inventors have recognized that by manufacturing one type of an item, instead of various different types of the item, a manufacturer may be able to reduce manufacturing costs by streamlining production lines. For example, a locomotive manufacturer may be able to reduce manufacturing costs by producing a single type of locomotive, such as a high tractive effort capability AC powered locomotive, instead of producing two types of locomotives, such as a high tractive effort capability AC powered locomotive and a low tractive effort capability DC powered locomotive.

What is needed is a locomotive that, for example, may be easily reconfigured as operating requirements for the locomotive change over its life. There is also a continuing need to reduce manufacturing costs. What is also needed is a locomotive truck that allocates weight differently to un-powered and powered axles, for example, of such a locomotive. Accordingly, the inventors have innovatively developed a reconfigurable locomotive that includes trucks that innovatively shift weight from a un-powered axle to a powered axle to achieve a desired tractive effort rating and/or an adhesion rating not achievable with symmetrically weighted axles.

### BRIEF SUMMARY OF THE INVENTION

An example embodiment of the invention includes a locomotive truck for distributing weight asymmetrically to axles of the truck. The truck includes a first axle uncoupled from a traction system of the locomotive and a first suspension assembly coupling the first axle to the truck for applying to the first axle a first portion of a locomotive weight. The truck also includes a second axle coupled to the traction system of the locomotive and a second suspension assembly coupling the second axle to the truck for applying to the second axle a second portion of the locomotive weight greater than the first portion of the locomotive weight so that weight is asymmetrically distributed to the first axle and the second axle, so as to transmit a corresponding incremental amount of tractive effort for a given amount of a driving torque applied to the second axle via the traction system of the locomotive.

In another example embodiment, the invention includes a locomotive truck for distributing weight asymmetrically to axles of the truck. The truck includes a first axle uncoupled from a traction system of the locomotive and a first suspension assembly coupling the first axle to the truck for applying to the first axle a first portion of a locomotive weight. The truck also includes a second axle coupled to the traction system of the locomotive and a second suspension assembly coupling the second axle to the truck for applying to the second axle a second portion of the locomotive weight. The truck also includes a third axle coupled to the traction system of the locomotive and a third suspension assembly coupling the third axle to the truck for applying to the third axle a third portion of the locomotive weight; the second and third portions of the locomotive weight being applied to the respective second axle and third axle greater than the first portion of the locomotive weight being applied to the first axle so that weight is asymmetrically distributed to the first axle, the second axle, and the third axle, so as to transmit a corresponding incremental amount of tractive effort for a given amount of a driving torque applied to the second axle and third axle via the traction system of the locomotive.

In another example embodiment, the invention includes a method for distributing weight asymmetrically to axles of a locomotive truck. The method includes uncoupling a first axle of the locomotive truck from a traction system of the locomotive and coupling the first axle to the truck with a first suspension assembly for applying to the first axle a first portion of a locomotive weight. The method also includes coupling a second axle of a locomotive truck to the traction system of the locomotive and coupling the second axle to the truck with a second suspension assembly for applying to the second axle a second portion of the locomotive weight greater than the first portion of the locomotive weight being applied to the first axle so that weight is asymmetrically distributed to the first axle and the second axle, so as to transmit a corresponding incremental amount of tractive effort for a given amount of a driving torque applied to the second axle via the traction system of the locomotive.

### BRIEF DESCRIPTION OF THE DRAWINGS

A more particular description of the invention briefly described above will be rendered by reference to specific embodiments thereof that are illustrated in the appended drawings. These drawings depict only typical embodiments of the invention and are not therefore to be considered to be limiting of its scope.

FIG. 1A is a schematic block diagram of an example embodiment of a reconfigurable locomotive having a truck for distributing a locomotive truck weight asymmetrically to axles of the locomotive.

FIG. 1B is a schematic block diagram of an example embodiment of a reconfigurable locomotive having a truck for distributing a locomotive truck weight asymmetrically to axles of the locomotive.

FIG. 2 is a flow diagram of an example embodiment of a method for distributing weight asymmetrically to axles of locomotive.

### DETAILED DESCRIPTION OF THE INVENTION

Reference will now be made in detail to the embodiments consistent with the invention, examples of which are illustrated in the accompanying drawings. Wherever possible, the same reference numerals are used throughout the drawings and refer to the same or like parts.

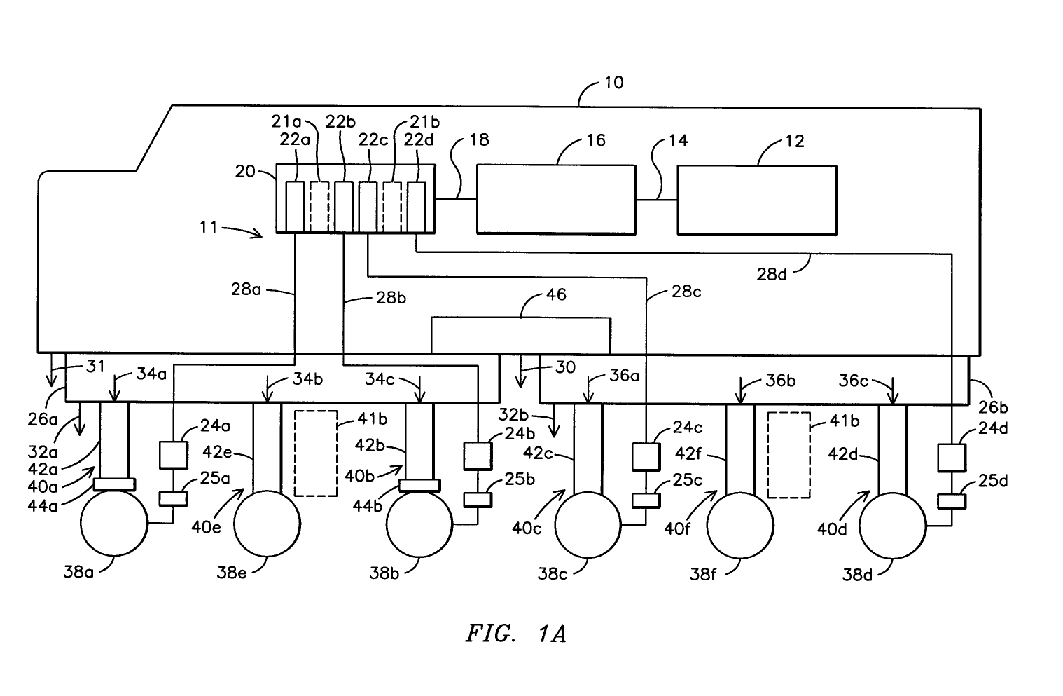

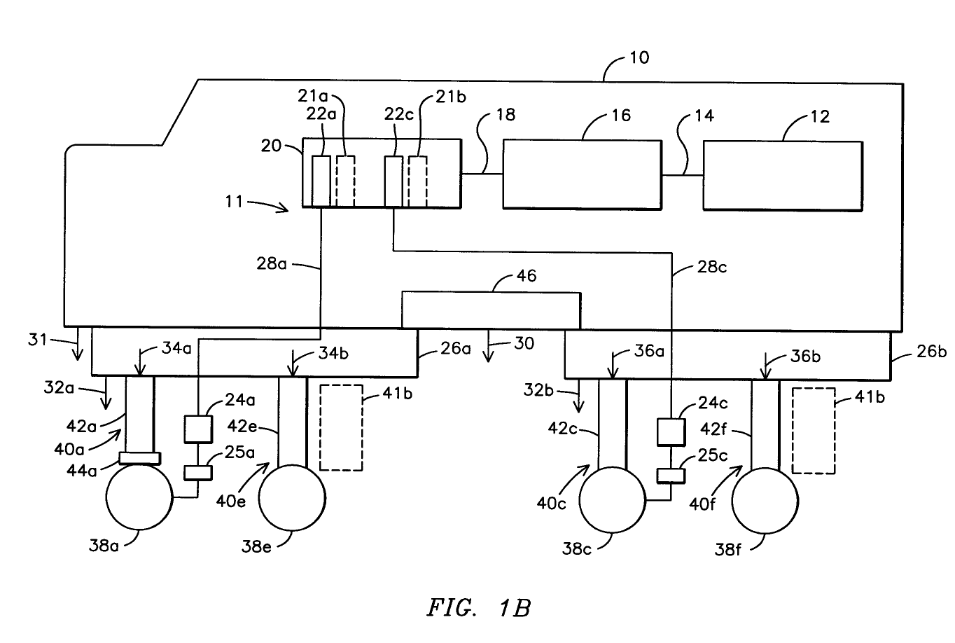

FIG. 1A is a schematic block diagram of an example embodiment of a reconfigurable locomotive 10. The locomotive 10 may include a traction system 11 having a diesel internal combustion engine 12 coupled via shaft 14 to drive a traction alternator 16 for producing AC electrical power 18. The AC electrical power 18 may be provided to a motor controller 20 that may include a one or more inverters 22a-22d. Inverters 22a-22d may be configured for providing electrical power to, and for controlling respective traction motors 24a-24d located in trucks 26a-26b. The inverters 22a-22d may be electrically coupled to the respective traction motors 24a-24d with wiring harnesses 28a-28b. In an aspect of the invention, the traction motors 24a-24d may include AC powered traction motors for converting AC electrical power into a mechanical power. The traction motors 24a-24d may be mechanically coupled to respective gear sets 25a-25d for applying power in the form of driving torque to the corresponding powered axle 38a-38d. It should be understood that although an AC type locomotive system is described above, aspects of the present invention may also be used with DC locomotives and other locomotive power configurations as well.

A static weight 30 of the locomotive 10, for example, including a locomotive body weight 31 and truck weights 32a, 32b, is supported by the axles 38a-38f of the trucks 26a-26b. Accordingly, the static weight 30 supported by any one axle may include a portion of the locomotive body weight 31 of the locomotive 10 supported by the truck to which the axle is coupled and the truck weight, e.g., truck weight 32a, 32b. The axles 38a-38f may be coupled to the trucks 26a, 26b by one or more suspension assemblies 40a-40f that may include one or more springs 42a-42f and/or shims 44a, 44b.

In an aspect of the invention, one or more axles of trucks 26a, 26b, such as axles 38e, 38f, may be left un-powered in a baseline configuration. Consequently, the associated assemblies normally deployed with the un-powered axles, such as inverters, traction motors, and/or gear sets, may be absent in a baseline configuration. By reducing a number of traction components, users requiring a less tractive effort capable and/or less powerful locomotive may be able to save on the cost of purchasing such a locomotive compared to a locomotive having a full complement of traction components. Furthermore, manufacturers of such locomotives may save on production costs because they only need to produce one baseline locomotive design and simply add traction components and/or refrain for installing traction components to achieve a desired capability of a locomotive, instead of having to produce entirely different models having different capabilities. Spaces in the locomotive 10 normally occupied by components of the traction system 11, such as a space 41a in the truck 26a normally reserved for housing a traction assembly, and or a space 21a in the motor controller 20, normally reserved for an inverter, may be left vacant in a baseline locomotive design.

In an example embodiment shown in FIG. 1B, the invention includes a locomotive truck, e.g. truck 26a, for distributing a locomotive truck weight asymmetrically to axles, e.g. a first axle 38a and a second axle 38e, of the truck 26a. Axle 38e of a locomotive truck 26a may be uncoupled from the traction system 11 of the locomotive 10 and a suspension assembly 40e may couple axle 38e to the truck 26a for applying to axle 38e a first portion 34b of the weight 30 of the locomotive 10. For example, truck 26a may be configured without a motor or gear set normally used for powering axle 38e. Accordingly, axle 38e may be configured to act as an un-powered, idler axle that functions to support portion 34b of the locomotive weight 30 in the absence of the traction system components normally needed to drive the axle 38e. Axle 38a of the locomotive truck 26a may be coupled to the traction system 11, and a suspension assembly 40a may couple the axle 38a to the truck 26a for applying to the axle 38a a second portion 34a of the weight 30 being applied by the locomotive 10. The portion 34b of the weight 30 may be different from the portion 34a of the weight 30 being applied to the axle 38a so that the locomotive weight 30 is asymmetrically distributed to axle 38e and axle 38a. This asymmetrical distribution of the weight 30 may be configured to allocate more weight to axle 38a so as to transmit a corresponding incremental amount of tractive effort for a given amount of a driving torque applied to the axle 38a via the traction system 11 of the locomotive 10.

In an embodiment, the portion 34a of the weight 30 applied to axle 38a coupled to the traction system 11 may be greater than portion 34b of the weight 30 applied to the axle 38e uncoupled from the traction system so that more weight is allocated to axle 38a. Accordingly, weight may be transferred from an un-powered axle 38e that does not provide tractive effort, to a powered axle 38a so that more tractive effort may be generated by axle 38a compared to a conventional configuration wherein the weight 30 is symmetrically distributed to the axles 38a, 38b. For example, if 5000 pounds of weight normally applied to axle 38e is relieved from bearing on axle 38e and allocated to axle 38a, an additional tractive effort proportional to the additional 5000 pounds allocated to axle 38a may be transmitted by axle 38a. Advantageously, by allocating more weight to the powered axle 38a, adhesion control may be improved compared to an arrangement wherein weight is symmetrically allocated to the axles 38a and 38e.

In an example embodiment for distributing weight asymmetrically, suspension assembly 40a and suspension assembly 40e may comprise respective springs 42a, 42b having different characteristics that provided different weight loading responses. For example, the different characteristics may comprise different spring constants and/or different spring geometries. For example, spring 42a may comprise a stiffer spring constant than a spring constant of spring 42e. In another embodiment, the different spring geometry may include a different spring length in a direction of spring compression. For example, a length of spring 42a may be longer than a length of spring 42e.

In another embodiment, suspension assembly 40a and suspension assembly 40e may include respective springs 42a, 42b having equivalent characteristics, wherein at least one of the suspension assembly 40a and suspension assembly 40e include a shim, e.g. shim 44a, for configuring the corresponding suspension assembly e.g. suspension assembly 40a to have a different characteristic than the other suspension assembly, e.g. suspension assembly 40e. For example, shim 44a may effectively shorten, or pre-compress, spring 42a so that more weight is allocated to axle 38a compared to an un-shimmed suspension assembly 40e including a spring 42e having an equivalent characteristic as spring 42a. In another aspect of the invention, a smaller wheel diameter of a less weighted axle 38e compared to a wheel diameter of a more weighted axle 38a may be initially proved due to the fact that the more weighted axle 38a will wear faster.

In yet another embodiment depicted in FIG. 1A, the locomotive truck may include a third axle, e.g. axle 38b, coupled to the traction system 11 of the locomotive 10 and another suspension assembly 40b coupling axle 38b to the truck 26a for applying to the axle 38b a third portion 34c of the weight 30. Portion 34c applied to the axle 38b may be different from portion 34b applied to axle 38e so that the weight 30 is asymmetrically distributed to axle 38a, axle 38e, and axle 38b. The asymmetrical distribution may be configured to allocate more weight to axle 38a and axle 38b so as to transmit a corresponding incremental amount of tractive effort for a given amount of a driving torque applied to axle 38a and axle 38b via the traction system 11 of the locomotive 10. For example, portion 34a and portion 34c applied to the respective axle 38a and axle 38b may be greater than the portion 34b of the weight 30 applied to axle 38e, so that more weight is allocated to axle 38a and axle 38b. In another aspect, the weights allocated to axle 38a and axle 38b may be symmetric with respect to each other, but different than the weight allocated to axle 38e.

In another embodiment, suspension assemblies 40a, 40e and 40b, include respective springs 42a, 42e and 42b having different characteristics. The different characteristics may include different spring constants and/or different characteristics comprise different spring geometries. For example, spring 42a may comprise a stiffer spring constant than a spring constant of spring 42e. In another embodiment, the different spring geometry may include a different spring length in a direction of spring compression. For example, a length of spring 42a may be longer than a length of spring 42e. In another example embodiment, springs 42a, 42e and 42b may include equivalent characteristics, wherein at least one of the first suspension assemblies 40a, 40e and 40b include a shim, such as shims 44a, 44b for configuring the corresponding suspension assembly e.g., suspension assembly 40a, 40b to have different characteristics than the other suspension assembly, e.g., suspension assembly 40e. For example, shim 44a may effectively shorten, or pre-compress, spring 42a so that more weight is allocated to axle 38a compared to an un-shimmed suspension assembly 40e including a spring 42e having an equivalent characteristic as spring 42a.

In another example embodiment, an amount and/or position of the ballast 46 on the locomotive 10 relative to the trucks 26a, 26b may be configured responsive to a number of axles coupled to the traction system 11 in the trucks 26a, 26b. For example, referring to FIG. 1B, if truck 26a has its two axles 38a, 38e coupled to the traction system 11, and truck 26b has axle 38c coupled to the traction system 11 and axle 38f uncoupled from the traction system 11, then the ballast 46 may be positioned on the locomotive 10 so that it is closer to truck 26a than 26b. Accordingly, the position of the ballast 46 may be configured to asymmetrically apply more of the weight to truck 26a to allow transmitting a corresponding incremental amount of tractive effort for a given amount of a driving torque applied to the coupled axles of truck 26a via the traction system 11 of the locomotive 10.

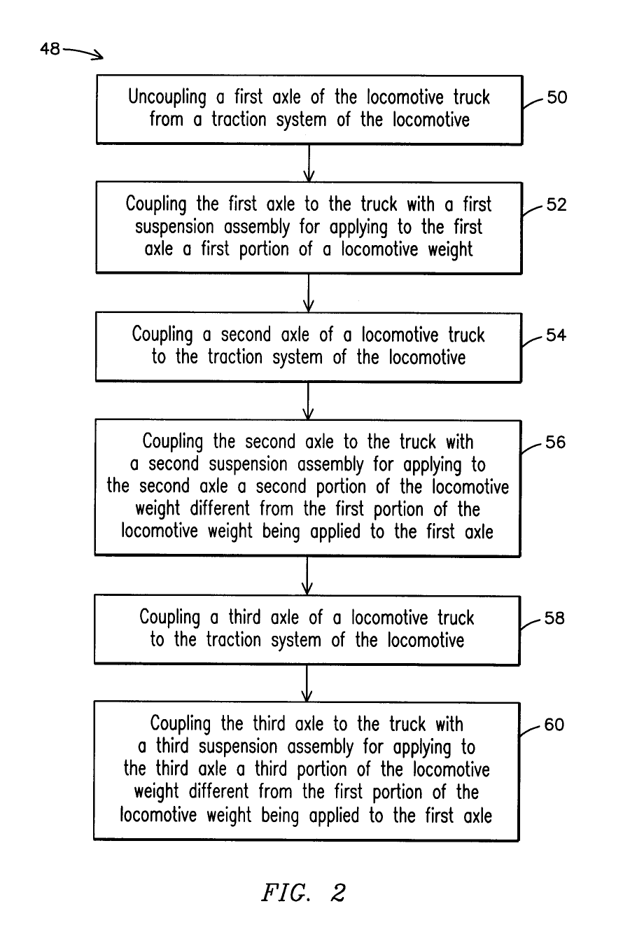

In another example embodiment depicted in the flow diagram 48 of FIG. 2, and with reference to FIG. 1A and FIG. 1B, a method for distributing a locomotive weight 30 asymmetrically to axles thereof may include uncoupling 50 axle 38e of the locomotive truck 26a from the traction system 11 of the locomotive 10. The method may also include coupling 52 axle 38e to the truck 26a with a first suspension assembly 40e for applying to the axle 38e a first portion 34b of a locomotive weight 30. The method may also include coupling 54 axle 38a to the traction system 11, and then coupling 56 axle 38a to the truck 26a with a second suspension assembly 40a for applying to axle 38a a second portion 34a of the locomotive weight 30 different from, such as greater than, portion 34b of the locomotive weight 30 being applied to axle 38e so that weight is asymmetrically distributed to axle 38a and axle 38e. In an aspect of the inventions, the asymmetrical distribution is configured to allocate more of the weight 30 to axle 38a so as to transmit a corresponding incremental amount of tractive effort for a given amount of a driving torque applied to axle 38a via the traction system 11 of the locomotive 10.

The method may further include coupling 58 a third axle, e.g. axle 38b of the locomotive truck 26a to the traction system 11 of the locomotive 10 and coupling 60 axle 38b to the truck 26a with a third suspension assembly for applying to axle 38b a third portion 34c of the weight 30 different from, such as greater than, the first portion 34b of the weight 30 being applied to axle 38e.

While exemplary embodiments of the invention have been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A locomotive truck comprising:
a first axle uncoupled from a traction system of the locomotive;
a first suspension assembly coupling the first axle to the truck, the first suspension assembly being configured to apply to the first axle a first portion of a locomotive weight;
a second axle coupled to the traction system of the locomotive; and
a second suspension assembly coupling the second axle to the truck, the second suspension assembly being configured to apply to the second axle a second portion of the locomotive weight greater than the first portion of the locomotive weight so that weight is asymmetrically distributed to the first axle and the second axle so as to allow transmitting a corresponding incremental amount of tractive effort for a given amount of a driving torque applied to the second axle via the traction system of the locomotive.

2. The locomotive truck of claim 1, wherein the first suspension assembly and the second suspension assembly comprise respective springs having different characteristics.

3. The locomotive truck of claim 2, wherein the different characteristics comprise different spring constants.

4. The locomotive truck of claim 2, wherein the different characteristics comprise different spring geometries.

5. The locomotive truck of claim 1, wherein the first suspension assembly and the second suspension assembly comprise respective springs having equivalent characteristics, at least one of the first suspension assembly and the second suspension assembly further comprising a shim for configuring the corresponding suspension assembly to have a different characteristic than the other suspension assembly.

6. The locomotive truck of claim 1, wherein the locomotive weight comprises a portion of a locomotive body weight of the locomotive supported by the truck and a portion of the truck weight.

7. The locomotive truck of claim 1, wherein the traction system comprises an alternating current traction motor.

8. A locomotive comprising the truck of claim 1.

9. The locomotive of claim 8, further comprising:
a second truck in addition to the truck of claim 1, the second truck comprising a third axle and a forth axle coupled to the traction system; and
a locomotive ballast disposed on the locomotive closer to the second truck than the truck of claim 1 so that weight is asymmetrically distributed to the second truck and the truck of claim 1 so as to allow transmitting a corresponding incremental amount of tractive effort for a given amount of a driving torque applied to the third axle and forth axle of the second truck via the traction system of the locomotive.

10. A locomotive truck comprising:
a first axle uncoupled from a traction system of the locomotive;
a first suspension assembly coupling the first axle to the truck the first suspension assembly being configured to apply to the first axle a first portion of a locomotive weight;
a second axle coupled to the traction system of the locomotive;
a second suspension assembly coupling the second axle to the truck, the second suspension assembly being configured to apply to the second axle a second portion of the locomotive weight;
a third axle coupled to the traction system of the locomotive; and
a third suspension assembly coupling the third axle to the truck, the third suspension assembly being configured to apply to the third axle a third portion of the locomotive weight, the second portion and third portion of the locomotive weight being applied to the respective second axle and third axle greater than the first portion of the locomotive weight being applied to the first axle so that weight is asymmetrically distributed to the first axle, the second axle, and the third axle, so as to allow transmitting a corresponding incremental amount of tractive effort for a given amount of a driving torque applied to the second axle and third axle via the traction system of the locomotive.

11. The locomotive truck of claim 10, wherein the first suspension assembly, the second suspension assembly, and the third suspension assembly comprise respective springs having different characteristics.

12. The locomotive truck of claim 11, wherein the different characteristics comprise different spring constants.

13. The locomotive truck of claim 11, wherein the different characteristics comprise different spring geometries.

14. The locomotive truck of claim 10, wherein the first suspension assembly, the second suspension assembly, and the third suspension assembly comprise respective springs having equivalent characteristics, at least one of the first suspension assembly, the second suspension assembly, and the third suspension assembly further comprising a shim for configuring the corresponding suspension assembly to have a different characteristic than at least one other suspension assembly.

15. The locomotive truck of claim 10, wherein the locomotive weight comprises a portion of a locomotive body weight of the locomotive supported by the truck and a portion of the truck weight.

16. The locomotive truck of claim 10, wherein the traction system comprises an alternating current traction motor.

17. A locomotive comprising the truck of claim 10.

18. A method for distributing weight asymmetrically to axles of a locomotive truck comprising:
uncoupling a first axle of the locomotive truck from a traction system of the locomotive;
coupling the first axle to the truck with a first suspension assembly for applying to the first axle a first portion of a locomotive weight;
coupling a second axle of a locomotive truck to the traction system of the locomotive; and
coupling the second axle to the truck with a second suspension assembly for applying to the second axle a second portion of the locomotive weight greater than the first portion of the locomotive weight being applied to the first axle so that weight is asymmetrically distributed to the first axle and the second axle, wherein the asymmetrical distribution is configured to allocate more weight to the second axle so as to allow transmitting a corresponding incremental amount of tractive effort for a given amount of a driving torque applied to the second axle via the traction system of the locomotive.

19. The method of claim 18, further comprising:
coupling a third axle of the locomotive truck to the traction system of the locomotive; and
coupling the third axle to the truck with a third suspension assembly for applying to the third axle a third portion of the weight greater than the first portion of the weight applied to the first axle.
